(19) United States
(12) Patent Application Publication
(10) Pub. No.: US 2026/0330890 A1
(43) Pub. Date: Oct. 22, 2026

(54) SYSTEMS AND METHODS FOR INTEGRATING A VEHICLE INTO A MARSHALING ENVIRONMENT

(71) Applicant: Ford Global Technologies, LLC, Dearborn, MI (US)

(72) Inventors: Stuart C. Salter, White Lake, MI (US); Brendan Diamond, Naples, FL (US); Ryan O'Gorman, Beverly Hills, MI (US); Krishna Bandi, Novi, MI (US); Vyas Darshan Shenoy, Canton, MI (US)

(73) Assignee: Ford Global Technologies, LLC, Dearborn, MI (US)

(21) Appl. No.: 19/180,897

(22) Filed: Apr. 16, 2025

(51) Int. Cl. G07C 5/00; G06Q 10/083; G07C 5/04; G07C 5/10; B60R 25/00

(52) U.S. Cl. CPC G07C 5/008; G06Q 10/083; G07C 5/04; G07C 5/10; B60R 25/00

(57) ABSTRACT

A method includes the determination of whether a vehicle is located within a distance-related threshold from an entry location of a marshaling environment, the performance of one or more capability tests and one or more functional control tests on the vehicle, the determination of whether the vehicle satisfies the one or more capability requirements and one or more functional control requirements, the provision to the vehicle of entry to the marshaling environment, and onboarding the vehicle to be autonomously marshaled through the marshaling environment.

### FIELD

The present disclosure relates to integrating one or more vehicles into a marshaling environment, and more particularly, re-integrating one or more vehicles into the marshaling environment.

### BACKGROUND

The statements in this section merely provide background information related to the present disclosure and may not constitute prior art.

A vehicle-related yard is typically a restricted place that requires security measures for protecting the yard from unauthorized and/or incompatible vehicles from entering the yard. However, the security measures implemented to protect the yard present many issues, such as incorrectly authorizing the vehicle, a lengthy process for authorizing the vehicle, among others.

The present disclosure addresses these and other issues related to the integration and/or re-integration of a vehicle into a yard.

### SUMMARY

This section provides a general summary of the disclosure and is not a comprehensive disclosure of its full scope or all of its features.

The present disclosure provides a method comprising: determining, by an infrastructure system, whether a vehicle is located within a distance-related threshold from an entry location of a marshaling environment; performing one or more capability tests and one or more functional control tests on the vehicle in response to determining that the vehicle is located within the distance-related threshold from the entry location of the marshaling environment; determining whether the vehicle satisfies one or more capability requirements and one or more functional control requirements based on the performance of the one or more capability tests and the one or more functional control tests, respectively; providing, to the vehicle, entry to the marshaling environment in response to determining that the vehicle satisfies the one or more capability requirements and the one or more functional control requirements; and onboarding the vehicle to be autonomously marshaled through the marshaling environment in response to the vehicle entering the marshaling environment; wherein performing the one or more capability tests comprises: synchronizing the infrastructure system with one or more vehicle controls of the vehicle; and monitoring one or more sensor outputs of the vehicle based on the synchronization of the infrastructure system with the one or more vehicle controls, wherein the one or more sensor outputs correspond to outputs originating from one or more vehicle systems of the vehicle, and wherein the one or more vehicle systems include at least one of an imaging system, a powertrain system, a braking system, a steering system, and a climate system; wherein performing the one or more capability tests comprises: assessing one or more capabilities of a sensor suite of the vehicle based on the synchronization of the infrastructure system with the one or more vehicle controls, wherein the one or more capabilities includes at least one of a field of vision, a sensor fidelity, a powertrain accuracy control, and a powertrain control precision; and determining whether the one or more capabilities are operational based on the assessment of the one or more capabilities of the sensor suite; wherein determining whether the one or more capabilities are operational is further based on historical test data and one or more operational vehicle requirements associated with the marshaling environment; wherein performing the one or more functional control tests comprises: transmitting one or more instructions to the vehicle; and causing the vehicle to perform one or more actions based on the one or more instructions, wherein the one or more actions include at least one of a steering-related action, a light-related action, a vehicle movement-related action, and a brake-related action; wherein performing the one or more functional control tests comprises: determining whether the performance of the one or more actions correspond to the one or more instructions; and generating a vehicle identifier associated with the vehicle in response to determining that the performance of the one or more actions correspond to the one or more instructions; further comprising: determining whether a human operator is present within the vehicle; authorizing, based on one or more access requirements of the marshaling environment, entry of the human operator to the marshaling environment further based on one or more credentials of the human operator and in response to determining that the human operator is present within the vehicle; and displaying one or more entry prompts to the human operator; and wherein providing entry to the marshaling environment is based on the human operator successfully acknowledging the one or more entry prompts.

The present disclosure provides a system comprising: an infrastructure system configured to: determine whether a vehicle is located within a distance-related threshold from an entry location of a marshaling environment, perform one or more capability tests and one or more functional control tests on the vehicle in response to determining that the vehicle is located within the distance-related threshold from the entry location of the marshaling environment, determine whether the vehicle satisfies one or more capability requirements and one or more functional control requirements based on the performance of the one or more capability tests and the one or more functional control tests, respectively, provide, to the vehicle, entry to the marshaling environment in response to determining that the vehicle satisfies the one or more capability requirements and the one or more functional control requirements, and onboard the vehicle to be autonomously marshaled through the marshaling environment in response to the vehicle entering the marshaling environment; and the vehicle configured to: receive one or more instructions at the vehicle, and perform one or more actions based on the one or more instructions, wherein the one or more actions include at least one of a steering-related action, a light-related action, a vehicle movement-related action, and a brake-related action; wherein the infrastructure system configured to perform the one or more capability tests is further configured to: synchronize the infrastructure system with one or more vehicle controls of the vehicle; and monitor one or more sensor outputs of the vehicle based on the synchronization of the infrastructure system with the one or more vehicle controls, wherein the one or more sensor outputs correspond to outputs originating from one or more vehicle systems of the vehicle, and wherein the one or more vehicle systems include at least one of an imaging system, a powertrain system, a braking system, a steering system, and a climate system; wherein the infrastructure system configured to perform the one or more capability tests is further configured to: assess one or more capabilities of a sensor suite of the vehicle based on the synchronization of the infrastructure system with the one or more vehicle controls, wherein the one or more capabilities includes at least one of a field of vision, a sensor fidelity, a powertrain accuracy control, and a powertrain control precision; and determine whether the one or more capabilities are operational based on the assessment of the one or more capabilities of the sensor suite, historical test data, and one or more operational vehicle requirements associated with the marshaling environment; wherein the infrastructure system configured to perform the one or more functional control tests is further configured to: determine whether the performance of the one or more actions correspond to the one or more instructions; and generate a vehicle identifier associated with the vehicle in response to determining that the performance of the one or more actions correspond to the one or more instructions; wherein the infrastructure system is further configured to: determine whether a human operator is present within the vehicle; authorize, based on one or more access requirements of the marshaling environment, entry of the human operator to the marshaling environment further based on one or more credentials of the human operator and in response to determining that the human operator is present within the vehicle; and display one or more entry prompts to the human operator; and wherein the provision of the entry to the marshaling environment is based on the human operator successfully acknowledging the one or more entry prompts.

The disclosure provides one or more non-transitory computer-readable media storing processor-executable instructions that, when executed by at least one processor, cause the at least one processor to: determine, by an infrastructure system, whether a vehicle is located within a distance-related threshold from an entry location of a marshaling environment; perform one or more capability tests and one or more functional control tests on the vehicle in response to determining that the vehicle is located within the distance-related threshold from the entry location of the marshaling environment; determine whether the vehicle satisfies one or more capability requirements and one or more functional control requirements based on the performance of the one or more capability tests and the one or more functional control tests, respectively; provide, to the vehicle, entry to the marshaling environment in response to determining that the vehicle satisfies the one or more capability requirements and the one or more functional control requirements; and onboard the vehicle to be autonomously marshaled through the marshaling environment in response to the vehicle entering the marshaling environment; wherein the at least one processor caused to perform the one or more capability tests is further caused to: synchronize the infrastructure system with one or more vehicle controls of the vehicle; and monitor one or more sensor outputs of the vehicle based on the synchronization of the infrastructure system with the one or more vehicle controls, wherein the one or more sensor outputs correspond to outputs originating from one or more vehicle systems of the vehicle, and wherein the one or more vehicle systems include at least one of an imaging system, a powertrain system, a braking system, a steering system, and a climate system; wherein the at least one processor caused to perform the one or more capability tests is further caused to: assess one or more capabilities of a sensor suite of the vehicle based on the synchronization of the infrastructure system with the one or more vehicle controls, wherein the one or more capabilities includes at least one of a field of vision, a sensor fidelity, a powertrain accuracy control, and a powertrain control precision; and determine whether the one or more capabilities are operational based on the assessment of the one or more capabilities of the sensor suite, historical test data, and one or more operational vehicle requirements associated with the marshaling environment; wherein the at least one processor caused to perform the one or more functional control tests is further caused to: transmit one or more instructions to the vehicle; and cause the vehicle to perform one or more actions based on the one or more instructions, wherein the one or more actions include at least one of a steering-related action, a light-related action, and a brake-related action; wherein the at least one processor caused to perform the one or more functional control tests is further caused to: determine whether the performance of the one or more actions correspond to the one or more instructions; and generate a vehicle identifier associated with the vehicle in response to determining that the performance of the one or more actions correspond to the one or more instructions; and wherein the at least one processor is further caused to: determine whether a human operator is present within the vehicle; authorize, based on one or more access requirements of the marshaling environment, entry of the human operator to the marshaling environment further based on one or more credentials of the human operator and in response to determining that the human operator is present within the vehicle; and display one or more entry prompts to the human operator, wherein the provision of the entry to the marshaling environment is based on the human operator successfully acknowledging the one or more entry prompts.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a system for automated vehicle marshaling in accordance with one or more embodiments of the present disclosure;

FIG. 2 illustrates an example vehicle marshaled by the system shown in FIG. 1 in accordance with one or more embodiments of the present disclosure;

FIG. 3 illustrates an implementation of a system for integrating/re-integrating a vehicle into a marshaling environment in accordance with one or more embodiments of the present disclosure;

FIG. 4 is a flowchart illustrating an example method for integrating/re-integrating a vehicle into a marshaling environment in accordance with one or more embodiments of the present disclosure;

FIG. 5 is a flowchart illustrating an example method for integrating/re-integrating a vehicle into a marshaling environment in accordance with one or more embodiments of the present disclosure; and

FIG. 6 is a block diagram illustrating an example computer system in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One or more herein described examples provide systems and methods for an enhanced means for integrating/re-integrating a vehicle into a marshaling environment. In one or more examples, the integration/re-integration process provides a means for enhancing accuracy in authorizing the vehicle and reducing time it takes to authorize the vehicle before providing, or denying, access to the marshaling environment to the vehicle.

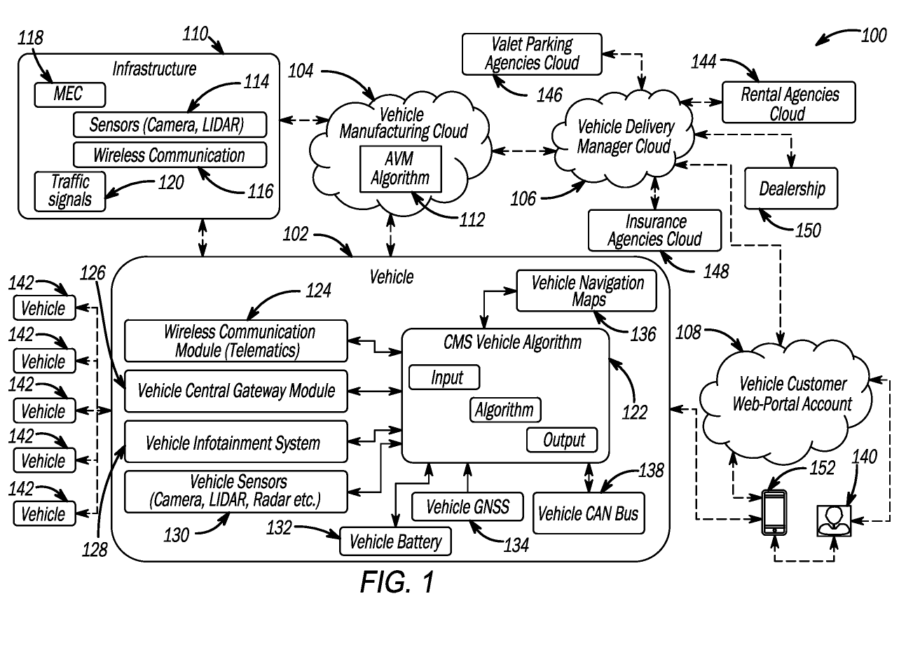

FIG. 1 shows a schematic block diagram illustrative of an automated vehicle marshaling (AVM) system 100. In one or more examples, the AVM system 100 marshals one or more vehicles (e.g., a vehicle 102) traveling at a low speed. However, it is understood that the AVM system 100 may marshal the one or more vehicles traveling at any speed. It is also understood that the AVM system 100 may marshal semi-autonomous vehicles and/or fully autonomous vehicles.

The AVM system 100 generally includes the vehicle 102, a vehicle manufacturing cloud system 104, a vehicle delivery manager cloud system 106, a vehicle customer web-portal account cloud system 108, and an infrastructure system 110. The vehicle manufacturing cloud system 104 operates as the central cloud system that manages and/or facilitates any manufacturing process associated with the vehicle 102. The vehicle manufacturing cloud system 104 is configured to wirelessly communicate with the vehicle delivery manager cloud system 106 and/or the infrastructure system 110. The vehicle manufacturing cloud system 104 is also configured to wirelessly communicate with the vehicle 102.

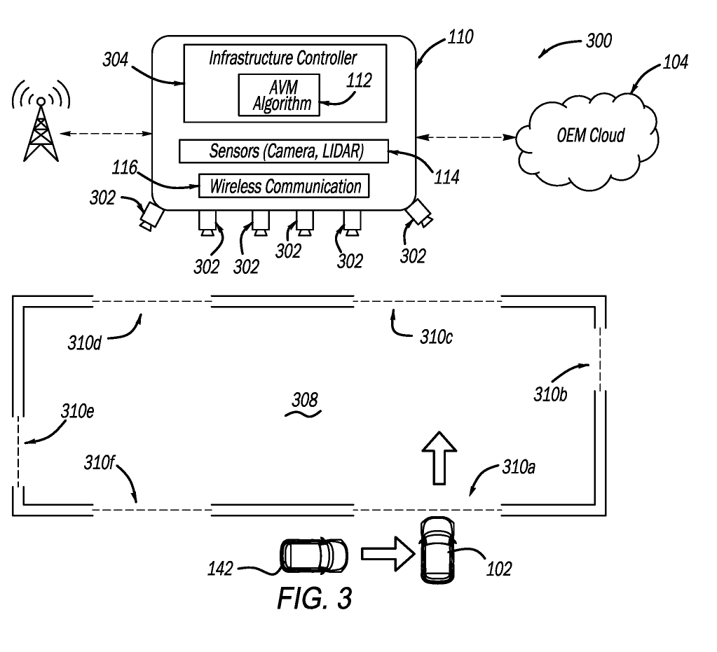

The vehicle manufacturing cloud system 104 can include an infrastructure-side AVM algorithm 112. However, it is understood that the infrastructure system 110 can include the infrastructure-side AVM algorithm 112 as well, as is shown in FIG. 3. The infrastructure-side AVM algorithm 112 processes status information associated with at least the vehicle 102 of the one or more vehicles. It is understood that the infrastructure-side AVM algorithm 112 processes status information associated with each vehicle of the one or more vehicles (e.g., the vehicle 102), in one or more embodiments. The vehicle manufacturing cloud system 104 is configured to cause the infrastructure system 110 to monitor the progression of the one or more vehicles (e.g., the vehicle 102) as the vehicle(s) progress through a marshaling environment. For example, the marshaling environment can represent a plant marshaling setting, an automated charging setting, a depot marshaling setting, a parking setting, among others. As an example, the plant marshaling setting can include an instance wherein just-built vehicles are moved through end-of-line testing at a vehicle assembly plant via overhead vision sensing (e.g., via a set of infrastructure sensors 302 as shown in FIG. 3). As another example, the automated charging setting can include an instance wherein vehicles are correctly allocated to automated charging modalities located outdoor or indoor. As a further example, the depot marshaling setting can include an instance wherein a commercial fleet of vehicles are moved through warehouses and depots to load and/or process items automatically. As an additional example, the parking setting can include an instance wherein vehicles are moved through underground or covered parking environments with a potentially inconsistent communication network such as a global navigation satellite system.

The vehicle manufacturing cloud system 104 is also configured to cause the infrastructure system 110 to communicate with the one or more vehicles. For example, the vehicle manufacturing cloud system 104 utilizes the infrastructure-side AVM algorithm 112 to send instructions to the infrastructure system 110 and/or to process information received from the infrastructure system 110. The vehicle manufacturing cloud system 104 is also configured to cause the vehicle delivery manager cloud system 106 to facilitate a delivery of the one or more vehicles (e.g., the vehicle 102) to various locations. For example, the vehicle manufacturing cloud system 104 utilizes the infrastructure-side AVM algorithm 112 to send instructions to the vehicle delivery manager cloud system 106 and/or to process information received from the vehicle delivery manager cloud system 106.

The vehicle manufacturing cloud system 104 is further configured to communicate directly with the one or more vehicles to cause the one or more vehicles to start, stop, or pause progression through the marshaling environment. The vehicle manufacturing cloud system 104 is also configured to control a marshaling speed of the one or more vehicles as the one or more vehicles travel through (e.g., traverse) the marshaling environment. For example, the vehicle manufacturing cloud system 104 utilizes the infrastructure-side AVM algorithm 112 to send instructions to the vehicle 102 and/or to process information received from the vehicle 102.

The infrastructure system 110 includes a sensor component 114, a wireless communication component 116, a multi-access edge computing (MEC) system 118, and one or more traffic signals 120. It is understood that the MEC system 118 is configured to support communication between the wireless communication component 116 and the vehicle 102. It is further understood, however, that the MEC system 118 is also configured to support communication between the wireless communication component 116 and any of the vehicle manufacturing cloud system 104, the vehicle delivery manager cloud system 106, and/or the vehicle customer web-portal account cloud system 108. For example, the wireless communication component 116 may utilize GPS, Wi-Fi, satellite, 3G/4G/5G, and/or Bluetooth^{®} to communicate with the one or more vehicles.

The wireless communication component 116 also communicates with the sensor component 114 that is configured to communicate with and/or manage the set of infrastructure sensors 302, as is described herein. In one or more examples, the sensor component 114 is also configured to perform one or more localization functions associated with marshaling the one or more vehicles such as, but not limited to, perception, path-planning, detection, controls, and/or receiving and analyzing response(s) from each vehicle of the one or more vehicles.

The wireless communication component 116 is also in communication with the traffic signals 120. For example, the wireless communication component 116 may cause the traffic signals 120 to direct traffic of the one or more vehicles as the one or more vehicles are marshaled through the marshaling environment. It is understood that the infrastructure system 110 can forward instructions received from the vehicle manufacturing cloud system 104 to the vehicle 102. However, it is also understood that the infrastructure system 110 can send instructions to the vehicle 102 directly through the utilization of the MEC system 118, for example.

The vehicle 102 includes a vehicle-side AVM algorithm 122, a wireless transmission module 124, a vehicle central gateway module 126, a vehicle infotainment system 128, one or more vehicle sensors 130, a vehicle battery 132, a vehicle GNSS 134, a vehicle navigation mapping system 136, and a controller area network (CAN) vehicle bus 138. The wireless transmission module 124 may be a transmission control unit (TCU) and/or may be supported by telematically supported subsystems. The wireless transmission module 124 includes one or more sensors that are configured to gather data and send signals to other components of the vehicle 102. The one or more sensors of the wireless transmission module 124 may include, but is not limited to, a vehicle speed sensor (not shown) configured to determine a current speed of the vehicle 102; a wheel speed sensor (not shown) configured to determine if the vehicle 102 is traveling at an incline or a decline; a throttle position sensor (not shown) configured to determine if a downshift or upshift of one or more gears associated with the vehicle 102 is required in a current status of the vehicle 102; and/or a turbine speed sensor (not shown) configured to send data associated with a rotational speed of a torque converter of the vehicle 102.

The wireless transmission module 124 communicates information, gathered by the one or more sensors, to the vehicle-side AVM algorithm 122. In one embodiment, the vehicle-side AVM algorithm 122 may be disposed as a component within the wireless transmission module 124. For example, the vehicle 102 utilizes the vehicle-side AVM algorithm 122 to process and send information gathered by the one or more sensors to the infrastructure system 110. As another example, the vehicle 102 utilizes the vehicle-side AVM algorithm 122 to process and send information gathered by the one or more sensors to the vehicle manufacturing cloud system 104 directly. The vehicle-side AVM algorithm 122 is configured to communicate information and/or instructions to the wireless transmission module 124 received from the infrastructure system 110 and/or the vehicle manufacturing cloud system 104.

The vehicle central gateway module 126 operates as an interface between various vehicle domain bus systems, such as an engine compartment bus (not shown), an interior bus (not shown), an optical bus for multimedia (not shown), a diagnostic bus for maintenance (not shown), or the vehicle CAN bus 138. The vehicle central gateway module 126 is configured to distribute data communicated to the vehicle central gateway module 126 by each of the various domain bus systems to other components of the vehicle 102. The vehicle central gateway module 126 is also configured to distribute information received from the vehicle-side AVM algorithm 122 to the various domain bus systems. The vehicle central gateway module 126 is further configured to send information to the vehicle-side AVM algorithm 122 received from the various domain bus systems. For example, the vehicle 102 utilizes the vehicle-side AVM algorithm 122 to process and send information received from the vehicle central gateway module 126 to the infrastructure system 110. As another example, the vehicle 102 utilizes the vehicle-side AVM algorithm 122 to process and send information received from the vehicle central gateway module 126 to the vehicle manufacturing cloud system 104 directly. The vehicle-side AVM algorithm 122 is configured to communicate information and/or instructions to the vehicle central gateway module 126 received from the infrastructure system 110 and/or the vehicle manufacturing cloud system 104.

The vehicle infotainment system 128 delivers a combination of information and entertainment content and/or services to a user 140 of the vehicle 102. It is understood that the vehicle infotainment system 128 can deliver only entertainment content to the user 140 of the vehicle 102, in some examples. It is also understood that the vehicle infotainment system 128 can deliver information services to anyone associated with the vehicle 102, in other examples. As an example, the vehicle infotainment system 128 includes built-in car computers that combine one or more functions, such as digital radios, built-in cameras, and/or televisions. The vehicle infotainment system 128 communicates information associated with the built-in car computers or processors to the vehicle-side AVM algorithm 122. For example, the vehicle 102 utilizes the vehicle-side AVM algorithm 122 to process and send information received from the vehicle infotainment system 128 to the infrastructure system 110. As another example, the vehicle 102 utilizes the vehicle-side AVM algorithm 122 to process and send information received from the vehicle infotainment system 128 to the vehicle manufacturing cloud system 104 directly. The vehicle-side AVM algorithm 122 is configured to communicate information and/or instructions to the vehicle infotainment system 128 received from the infrastructure system 110 and/or the vehicle manufacturing cloud system 104.

The one or more vehicle sensors 130 may be, for example, one or more of cameras, lidar, radar, and/or ultrasonic devices. For example, ultrasonic devices utilized as the one or more vehicle sensors 130 emit a high frequency sound wave that hits a wall or another vehicle and is then reflected back to the vehicle 102. Based on the amount of time it takes for the sound wave to return to the vehicle 102, the vehicle 102 can determine the distance between the one or more vehicle sensors 130 and the wall or the other vehicle. As another example, camera devices utilized as the one or more vehicle sensors 130 provide a visual indication of a space around the vehicle 102. As an additional example, radar devices utilized as the one or more vehicle sensors 130 emit electromagnetic wave signals that hit the wall or the other vehicle and is then reflected back to the vehicle 102. Based on the amount of time it takes for the electromagnetic waves to return to the vehicle 102, the vehicle 102 can determine a range, velocity, and angle of the vehicle 102 relative to the wall or the other vehicle.

The one or more vehicle sensors 130 communicate information associated with the position and/or distance at which the vehicle 102 is located relative to the wall or the other vehicle to the vehicle-side AVM algorithm 122. For example, the vehicle 102 utilizes the vehicle-side AVM algorithm 122 to process and send information received from the one or more vehicle sensors 130 to the infrastructure system 110. As another example, the vehicle 102 utilizes the vehicle-side AVM algorithm 122 to process and send information received from the one or more vehicle sensors 130 to the vehicle manufacturing cloud system 104 directly. The vehicle-side AVM algorithm 122 is configured to communicate information and/or instructions to the one or more vehicle sensors 130 received from the infrastructure system 110 and/or the vehicle manufacturing cloud system 104.

The vehicle battery 132 is controlled by a battery management system (not shown) that provides instructions to the vehicle battery 132. For example, the battery management system provides instructions to the vehicle battery 132 based on a temperature of the vehicle battery 132. However, it is understood that the battery management system may provide instructions to the vehicle battery 132 based on any measure associated with the vehicle battery 132 such as power state of the vehicle 102, a time period that the vehicle 102 is in an off-state, or a combination thereof. The battery management system ensures acceptable current modes of the vehicle battery 132. For example, the acceptable current modes protect against overvoltage, overcharge, and/or overheating of the vehicle battery 132. As another example, the temperature of the vehicle battery 132 indicates to the battery management system whether any of the acceptable current modes are within acceptable temperate ranges. The battery management system associated with the vehicle battery 132 communicates information associated with the temperature of the vehicle battery 132 to the vehicle-side AVM algorithm 122. For example, the vehicle 102 utilizes the vehicle-side AVM algorithm 122 to process and send information received regarding the vehicle battery 132 to the infrastructure system 110. As another example, the vehicle 102 utilizes the vehicle-side AVM algorithm 122 to process and send information regarding the vehicle battery 132 to the vehicle manufacturing cloud system 104 directly. The vehicle-side AVM algorithm 122 is configured to communicate information and/or instructions to the vehicle battery 132 received from the infrastructure system 110 and/or the vehicle manufacturing cloud system 104.

The vehicle GNSS 134 is configured to communicate with satellites so that the vehicle 102 can determine a specific location of the vehicle 102. The vehicle navigation mapping system 136 can display, via a display screen (not shown), the specific location of the vehicle 102 to the user 140. The vehicle GNSS 134 communicates geographical information associated with the vehicle 102 to the vehicle-side AVM algorithm 122. For example, the vehicle 102 utilizes the vehicle-side AVM algorithm 122 to process and send information received from the vehicle GNSS 134 to the infrastructure system 110. As another example, the vehicle 102 utilizes the vehicle-side AVM algorithm 122 to process and send information from the vehicle GNSS 134 to the vehicle manufacturing cloud system 104 directly. The vehicle-side AVM algorithm 122 is configured to communicate information and/or instructions to the vehicle GNSS 134 received from the infrastructure system 110 and/or the vehicle manufacturing cloud system 104. As another example, the vehicle 102 utilizes the vehicle-side AVM algorithm 122 to process and send information associated with the vehicle navigation mapping system 136 to the infrastructure system 110. As another example, the vehicle 102 utilizes the vehicle-side AVM algorithm 122 to process and send information from the vehicle navigation mapping system 136 to the vehicle manufacturing cloud system 104 directly. The vehicle-side AVM algorithm 122 is configured to communicate information and/or instructions to the vehicle navigation mapping system 136 received from the infrastructure system 110 and/or the vehicle manufacturing cloud system 104.

The vehicle 102 is configured to communicate any information associated with any of the components included within the vehicle 102 to one or more additional vehicles 142. The vehicle 102 is also configured to communicate (e.g., forward) any instructions received from the infrastructure system 110 and/or the vehicle manufacturing cloud system 104 to any of the one or more additional vehicles 142. For example, the communication of the vehicle 102 with the one or more additional vehicles 142 can aid the infrastructure system 110 and/or the vehicle manufacturing cloud system 104 in marshaling the one or more additional vehicles 142. It is understood that each of the one or more additional vehicles 142 can include any of the components described as being included within the vehicle 102, such as, but not limited to, the vehicle-side AVM algorithm 122, the wireless transmission module 124, the vehicle central gateway module 126, the vehicle infotainment system 128, the one or more vehicle sensors 130, the vehicle battery 132, the vehicle GNSS 134, the vehicle navigation mapping system 136, and/or the CAN vehicle bus 138, for example. It is also understood that any of the one or more additional vehicles 142 is configured to communicate information associated with any of the components included therein with the vehicle 102. It is further understood that the one or more additional vehicles 142 can also be configured to establish a direct line of wireless communication (e.g., via a communication link) with the infrastructure system 110 and/or the vehicle manufacturing cloud system 104, whereby information can be directly exchanged between the one or more additional vehicles 142 and the infrastructure system 110 and/or the vehicle manufacturing cloud system 104.

The vehicle delivery manager cloud system 106 wirelessly communicates (e.g., receives and/or sends instructions and/or information) with one or more of a rental agency cloud system 144, a valet parking agency cloud system 146, an insurance agency cloud system 148, and/or a dealership system 150. The vehicle delivery manager cloud system 106 is configured to facilitate the delivery of the one or more vehicles to, for example, any of a rental agency (not shown) associated with the rental agency cloud system 144, a valet parking agency (not shown) associated with the valet parking agency cloud system 146, an insurance agency (not shown) associated with the insurance agency cloud system 148, and/or the dealership system 150. The vehicle delivery manager cloud system 106 also wirelessly communicates with the vehicle customer web-portal account cloud system 108. It should be understood that other cloud systems can be included, in one or more examples.

The vehicle delivery manager cloud system 106 wirelessly communicates with a user device 152 such as, but not limited to, a mobile device, a display panel, and/or a computer. The vehicle 102 is also configured to wirelessly communicate directly with the user device 152. For example, the user 140 engages with the user device 152 via an application that organizes any information and/or instructions received from the vehicle customer web-portal account cloud system 108 and/or the vehicle 102. As another example, the user 140 may send one or more instructions to the vehicle customer web-portal account cloud system 108 such as making a selection of which vehicle the user 140 would like to receive from any of the rental agency associated with the rental agency cloud system 144, the valet parking agency associated with the valet parking agency cloud system 146, the insurance agency associated with the insurance agency cloud system 148, and/or the dealership system 150.

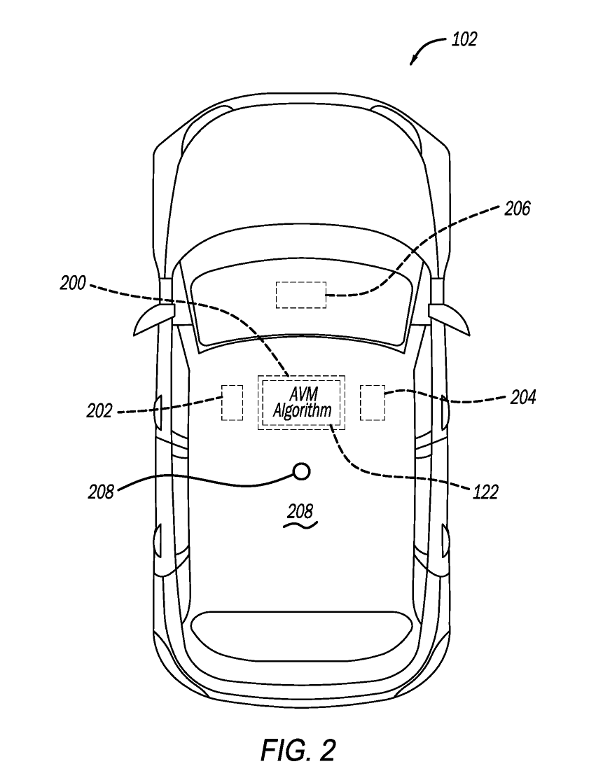

Referring to FIG. 2, in various forms, the vehicle(s) 102 may be powered in a variety of ways, for example, with an electric motor and/or an internal combustion engine. It is understood that the vehicle(s) 102 may be any type of vehicle powered by an electric motor and/or an internal combustion engine such as a car, a truck, a robot, a plane, and/or a boat. The vehicle(s) 102 generally includes a vehicle controller 200, one or more actuators 202, a plurality of on-board sensors 204, a human machine interface (HMI) 206, and a vehicle system 208. The vehicle(s) 102 also has a reference point 210, that is, a specified point within a space defined by a vehicle body that identifies the location of the vehicle(s) 102. For example, the reference point 210 is a geometrical center point at which respective longitudinal and lateral center axes of the vehicle(s) 102 intersects. As another example, the reference point 210 is a point at which the vehicle(s) 102 is located as the vehicle(s) 102 navigates toward a waypoint.

The plurality of on-board sensors 204 includes a variety of devices to provide data to the vehicle controller 200. For example, the plurality of on-board sensors 204 may include object detection sensors (e.g., lidar sensor(s)) disposed on or in the vehicle(s) 102 that provide relative locations, sizes, and/or shapes of one or more objects surrounding the vehicle(s) 102, such as additional vehicles, bicycles, robots, drones, etc., travelling next to, ahead, and/or behind the vehicle(s) 102. As another example, one or more of the plurality of on-board sensors 204 can be radar sensor(s) affixed to one or more bumpers of the vehicle(s) 102 that may provide locations of the object(s) relative to the location of each of the vehicle(s) 102. As yet another example, one or more of the plurality of on-board sensors 204 can be configured to monitor one or more functionalities associated with one or more internally-based components of the vehicle(s) 102.

The plurality of on-board sensors 204 may include a camera sensor, for example, to provide a front view, side view, rear view, etc., providing images from an area surrounding the vehicle(s) 102. As another example, the vehicle controller 200 may be programmed to receive sensor data from a camera sensor(s) and to implement image processing techniques to detect a road, infrastructure elements, etc. The vehicle controller 200 may be programmed to determine a current vehicle location based on location coordinates (e.g., GPS coordinates) received from the vehicle(s) 102 indicative of a location of the vehicle(s) 102 from a GPS sensor (not shown).

The vehicle controller 200, in some examples, is configured or programmed to control the operation of one or more of vehicle brakes, propulsion (e.g., control of acceleration in the vehicle(s) 102 by controlling one or more of an internal combustion engine, electric motor, hybrid engine, etc.), steering, climate control, interior and/or exterior lights, etc. The vehicle controller 200, in other examples, is further configured or programmed to determine whether and when the vehicle controller 200, as opposed to a human operator, is to control such operations related to the vehicle(s) 102. It is understood that any of the operations associated with the vehicle(s) 102 may be facilitated via an automated, a semi-automated, or a manual mode. For example, the automated mode may facilitate any of the operations to be fully controlled by the vehicle controller 200 without the aid of the human operator. As another example, the semi-automated mode may facilitate any of the operations to be at least partially controlled by the human operator in combination with the vehicle controller 200. As a further example, the manual mode may facilitate the operations to be fully controlled by the human operator without the aid of the vehicle controller 200.

The vehicle controller 200 includes, or may be communicatively coupled to (e.g., via a vehicle communications bus), one or more processors (not shown). For example, the one or more processors can be a controller, or the like, included in the vehicle(s) 102 for monitoring and/or controlling various vehicle controllers, such as a powertrain controller, a brake controller, a steering controller, etc. The vehicle controller 200 is generally arranged for various communications on a vehicle communication network (not shown) that can include a bus in the vehicle(s) 102 such as a CAN bus, or the like, and/or other wired and/or wireless mechanisms.

Via a vehicle network, the vehicle controller 200 transmits messages to various devices in the vehicle(s) 102 and/or receives messages from the various devices, for example, the one or more actuators 202, the HMI 206, etc. Alternatively, or additionally, in cases where the vehicle controller 200 includes multiple devices, the vehicle communication network is utilized for communications between devices represented as the vehicle controller 200 in this disclosure. Further, as is discussed below, various other controllers and/or sensors provide data to the vehicle controller 200 via the vehicle communication network.

In addition, the vehicle controller 200, via the vehicle-side AVM algorithm 122, is also configured to communicate through a vehicle-to-infrastructure communication network, such as communicating with an infrastructure controller (e.g., an infrastructure controller 304 as shown in FIG. 3). The vehicle controller 200, via the vehicle-side AVM algorithm 122, is also configured for communicating through a wireless vehicular communication interface with other traffic objects (e.g., vehicles, infrastructures, etc.), such as, via a vehicle-to-vehicle communication network. The vehicular communication network represents one or more mechanisms by which the vehicle controller 200 of the vehicle(s) 102 communicates with other traffic objects. As an example, the vehicular communication network may be one or more of wireless communication mechanisms, including any desired combination of wireless (e.g., cellular, wireless, satellite, microwave, and/or radio frequency) communication mechanisms and any desired network topology (or topologies when multiple communication mechanisms are utilized). Examples of vehicular communication networks include, among others, cellular, Bluetooth®, IEEE 802.11, dedicated short range communications (DSRC), and/or wide area networks (WAN), including the Internet, providing data communication services.

The one or more actuators 202 are implemented via circuits, chips, or other electronic and/or mechanical components that can actuate various vehicle subsystems in accordance with appropriate control signals. The one or more actuators 202 may be used to control braking, acceleration, and/or steering of the vehicle(s) 102. The vehicle controller 200 can be programmed to activate the one or more actuators 202 including propulsion, steering, and/or braking based on the planned acceleration or deceleration of the vehicle(s) 102.

The HMI 206 is configured to receive information from the human operator during operation of the vehicle(s) 102. Moreover, the HMI 206 is configured to present information to the human operator, such as an occupant of the vehicle(s) 102. In some variations, the vehicle controller 200 is programmed to receive destination data (e.g., location coordinates) from the HMI 206.

The vehicle system 208 is configured to control each of the subsystems within the vehicle(s) 102 and facilitate requests across each of the above-described components (e.g., the vehicle controller 200, the one or more actuators 202, the plurality of on-board sensors 204, and/or the HMI 206). Accordingly, the vehicle(s) 102 can be autonomously guided toward a waypoint using at least the plurality of on-board sensors 204. Routing can be performed using vehicle location, distance to travel, queue in line for vehicle marshaling, etc.

In one or more embodiments, FIG. 3 shows a system 300 configured to provide a means for onboarding the vehicle 102 (e.g., and/or the one or more additional vehicles 142). More specifically, onboarding the vehicle 102 (e.g., and/or the one or more additional vehicles 142) within the bounds offered by the system 300 is a process ultimately performed in response to providing entry of the vehicle 102 (e.g., and/or the one or more additional vehicles 142) to the marshaling environment 308, as described herein.

In one or more embodiments, the infrastructure system 110 includes the sensor component 114 that communicates with the set of infrastructure sensors 302. The set of infrastructure sensors 302 are configured to monitor the movement of the vehicle 102 (e.g., and/or the one or more additional vehicles 142) as the vehicle 102 (e.g., and/or the one or more additional vehicles 142) moves through the marshaling environment 308. The infrastructure system 110 also includes the wireless communication component 116 that provides a means for communication between the infrastructure system 110 and at least one communication node 310. However, it is understood that the wireless communication component 116 also provides a means for direct communication between the infrastructure system 110 and the vehicle 102 (e.g., and/or the one or more additional vehicles 142).

In one or more examples, movement of the vehicle 102 (e.g., and/or the one or more additional vehicles 142) through the manufacturing environment 308 is monitored based on a field of view of the set of infrastructure sensors 302. As another example, movement of the vehicle 102 (e.g., and/or the one or more additional vehicles 142) through the manufacturing environment 308 is also monitored based on one or more infrastructure marshaling messages (e.g., IMMs) and one or more vehicle marshaling messages (e.g., VMMs) exchanged between the vehicle 102 (e.g., and/or the one or more additional vehicles 142) and the infrastructure system 110.

Additionally, the infrastructure system 110 includes the infrastructure controller 304. The infrastructure controller 304 is configured to centrally control an operation of the vehicle 102 (e.g., and/or the one or more additional vehicles 142). For example, the operation of the vehicle 102 (e.g., and/or the one or more additional vehicles 142) includes propulsion, braking, and/or steering of the vehicle 102 (e.g., and/or the one or more additional vehicles 142). It is understood that the infrastructure controller 304 may be disposed within the infrastructure system 110 or externally located relative to the infrastructure system 110. The infrastructure controller 304 includes the infrastructure-side AVM algorithm 112 that is configured to facilitate communication between the infrastructure controller 304 and the vehicle controller 200 associated with the vehicle 102 (e.g., and/or the one or more additional vehicles 142).

In one or more embodiments, the infrastructure-side AVM algorithm 112 is configured to detect a presence of the vehicle 102 (e.g., and/or the one or more additional vehicles 142) in relation to one or more entry locations 310a-310f via at least the one or more sensors 302. In one or more examples, the infrastructure-side AVM algorithm 112 is also configured to determine whether the vehicle 102 (e.g., and/or the one or more additional vehicles 142) is located within a distance-related threshold from any of the one or more entry locations 310a-310f. As another example, the distance-related threshold can be any predefined distance from any of the one or more entry locations 310a-310fthat corresponds to a field of view of the one or more sensors 302 and/or a communicative range from the infrastructure system 110 (e.g., or the at least one communication node 310).

In response to determining that the vehicle 102 (e.g., and/or the one or more additional vehicles) is located within the distance-related threshold from any of the one or more entry locations 310a-310f, the infrastructure-side AVM algorithm 112 is configured to communicate with the vehicle (e.g., and/or the one or more additional vehicles 142 to facilitate the performance of one or more tests that are relied upon to ensure that the vehicle 102 (e.g., and/or the one or more additional vehicles 142) is functionally able to be controlled by the infrastructure system 110 as well as meet each of the one or more requirements necessary for the vehicle 102 (e.g., and/or the one or more additional vehicles 142) to operate within the marshaling environment 308.

In one or more examples, the one or more requirements can include, but are not limited to, one or more capability requirements as well as one or more functional control requirements of the vehicle 102 (e.g., and/or the one or more additional vehicles 142). As another example, the one or more tests can include, but are not limited to, one or more capability tests as well as one or more functional control tests of the vehicle 102 (e.g., and/or the one or more additional vehicles 142).

In one or more examples, one or more controls of the infrastructure-side AVM algorithm 112 are configured to synchronize with one or more controls of the vehicle 102 (e.g., and/or the one or more additional vehicles 142) to determine whether the vehicle 102 (e.g., and/or the one or more additional vehicles 142) can be controlled by the infrastructure-side AVM algorithm 112. As another example, the vehicle-side AVM algorithm 122 is configured to permit access to the one or more controls of the vehicle 102 (e.g., and/or the one or more additional vehicles 142) to the infrastructure-side AVM algorithm 112.

For example, the infrastructure-side AVM algorithm 112 is configured to synchronize with at least the one or more sensors of the wireless transmission module 124 of the vehicle 102 (e.g., and/or the one or more additional vehicles 142) to monitor a real-time sensor output related to at least one of an imaging system, a powertrain system, a braking system, a steering system, and a climate system. It is understood, however, that the infrastructure-side AVM algorithm 112 is configured to monitor a real-time sensor output related to any system associated with at least the one or more sensors of the wireless transmission module 124 of the vehicle 102 (e.g., and/or the one or more additional vehicles 142).

As another example, the infrastructure-side AVM algorithm 112 is also configured to synchronize with at least the one or more vehicle sensors 130 of the vehicle 102 (e.g., and/or the one or more additional vehicles 142) to assess one or more capabilities of each sensor of the one or more vehicle sensors 130. As another example, the one or more capabilities can include at least one of a field of vision, a sensor fidelity, a powertrain accuracy control, and a powertrain control precision. As yet another example, the assessment of the one or more capabilities of each sensor of the one or more vehicle sensors 130 is utilized as a basis for the infrastructure-side AVM algorithm 112 to determine whether the one or more capabilities are operational to ensure that the one or more vehicle sensors 130 will not cause any operational-related issues with any vehicles already provided access to the marshaling environment 308. As a further example, the infrastructure-side AVM algorithm 112 is further configured to access one or more technical specifications of each sensor of the one or more sensors 130 to determine one or more features of each sensor of the one or more sensors 130 such as, but not limited to, a sensor type, a model number, or any other sensor-related feature.

As another example, the infrastructure-side AVM algorithm 112 is additionally configured to perform one or more tests on the vehicle 102 (e.g., and/or the one or more additional vehicles 142) to verify that a communication-related system(s) of the vehicle 102 (e.g., and/or the one or more additional vehicles 142) is compatible with the infrastructure system 110 and/or one or more vehicles already provided access to the marshaling environment 308. As yet another example, the communication-related system(s) of the vehicle 102 (e.g., and/or the one or more additional vehicles 142) is compatible with the infrastructure system 110 and/or one or more vehicles already provided access to the marshaling environment 308 in a case wherein the vehicle 102 (e.g., and/or the one or more additional vehicles 142) utilizes the same communication protocol(s) and/or security measures as the infrastructure system 110 and/or one or more vehicles already provided access to the marshaling environment 308.

As a further example, the infrastructure-side AVM algorithm 112 is also configured to perform one or more tests on the vehicle 102 (e.g., and/or the one or more additional vehicles 142) to verify that the communication-related system(s) of the vehicle 102 (e.g., and/or the one or more additional vehicles 142) is controllable. For example, the communication-related system(s) of the vehicle 102 (e.g., and/or the one or more additional vehicles 142) is controllable in a case wherein the vehicle 102 (e.g., and/or the one or more additional vehicles 142) has one or more functions that permit the vehicle 102 (e.g., and/or the one or more additional vehicles 142) to be controlled by at least the infrastructure system 110 and/or whether the one or more functions are operating correctly (e.g., as expected – the system is operational without errors).

As another example, the infrastructure-side AVM algorithm 112 is additionally configured to perform one or more tests on the vehicle 102 (e.g., and/or the one or more additional vehicles 142) to verify that the communication-related system(s) of the vehicle 102 (e.g., and/or the one or more additional vehicles 142) is functioning correctly (e.g., as expected – the system is operational without errors).

In one or more embodiments, the infrastructure-side AVM algorithm 112 is configured to verify whether the communication-related system(s) is compatible, controllable, and/or functioning as expected associated with the infrastructure system 110 and/or one or more vehicles already provided access to the marshaling environment 308 by testing communication exchanged between the vehicle 102 (e.g., and/or the one or more additional vehicles 142) and the infrastructure system 110. The infrastructure-side AVM algorithm 112 is also configured to test communication exchanged between the vehicle 102 (e.g., and/or the one or more additional vehicles 142) and one or more vehicles already provided access to the marshaling environment 308. In one or more examples, the communication exchanged between at least the vehicle 102 (e.g., and/or the one or more additional vehicles 142) and the infrastructure system 110 can include an onboarding request, an entry request, or any other type of request that can be transmitted from the vehicle 102 (e.g., and/or the one or more additional vehicles 142) and received at the infrastructure system 110.

As yet another example, the infrastructure-side AVM algorithm 112 is configured to make one or more determinations related to one or more operational capabilities of the vehicle 102 (e.g., and/or the one or more additional vehicles 142) based on one or more operational vehicle requirements and/or one or more functional vehicle requirements associated with the marshaling environment 308. It is understood that the one or more operational vehicle requirements can include, but is not limited to, one or more predefined rules for moving through the marshaling environment 308. It is also understood that the one or more functional vehicle requirements can include, but is not limited to, a functionality of one or more lighting mechanisms of the vehicle 102 (e.g., and/or the one or more additional vehicles 142), a functionality of one or more steering capabilities of the vehicle 102 (e.g., and/or the one or more additional vehicles 142), and/or one or more stopping/starting capabilities of the vehicle 102 (e.g., and/or the one or more additional vehicles 142).

In one or more examples, the infrastructure-side AVM algorithm 112 is also configured to consider one or more ranges of acceptable capabilities as an alternative or an additional basis for determining whether the vehicle 102 (e.g., and/or the one or more additional vehicles 142) satisfy the one or more capability requirements. For example, the one or more ranges of acceptable capabilities can be established based on a specification of one or more minimum capabilities needed to function without issue within the marshaling environment 308. As another example, the one or more minimum capabilities can be predefined or based on historical testing data obtained from previous tests related to capability requirements of previously communicated-with vehicles.

As another example, the infrastructure-side AVM algorithm 112 is also configured to validate one or more functional controls of the vehicle 102 (e.g., and/or the one or more additional vehicles 142) to determine whether the vehicle 102 (e.g., and/or the one or more additional vehicles 142) satisfy the one or more functional control requirements via the synchronization of the one or more controls of the vehicle 102 (e.g., and/or the one or more additional vehicles 142) and the one or more controls of the infrastructure-side AVM algorithm 112. Alternatively, or in addition to the synchronization of the one or more controls of the vehicle 102 (e.g., and/or the one or more additional vehicles 142) and the one or more controls of the infrastructure-side AVM algorithm 112, the infrastructure-side AVM algorithm 112 is configured to communicate with (e.g., via one or IMMs and/or VMMs) the vehicle 102 (e.g., and/or the one or more additional vehicles 142) to validate one or more functional controls of the vehicle 102 (e.g., and/or the one or more additional vehicles 142) to determine whether the vehicle 102 (e.g., and/or the one or more additional vehicles 142) satisfy the one or more functional control requirements.

For example, the infrastructure-side AVM algorithm 112 is configured to perform one or more tests on one or more systems of the vehicle 102 (e.g., and/or the one or more additional vehicles 142) related to systems needed for the vehicle 102 (e.g., and/or the one or more additional vehicles 142) to function correctly (e.g., as expected) within the marshaling environment 308. In one or more examples, non-limiting examples of systems needed for the vehicle 102 (e.g., and/or the one or more additional vehicles 142) to function correctly (e.g., as expected) within the marshaling environment 308 include steering systems, lighting systems, braking systems, or any other operational system of the vehicle 102 (e.g., and/or the one or more additional vehicles 142).

As another example, the infrastructure-side AVM algorithm 112 is configured to confirm that a response received from the vehicle 102 (e.g., and/or the one or more additional vehicles 142) is consistent with one or more infrastructure commands while located within the distance-related threshold from any of the one or more entry locations 310a-310f. In one or more examples, one or more responses received from the vehicle 102 (e.g., and/or the one or more additional vehicles 142) can be based on a performance of one or more tests such as turning on/off light(s) of the vehicle 102 (e.g., and/or the one or more additional vehicles 142), the vehicle 102 (e.g., and/or the one or more additional vehicles 142) moving a controlled distance (e.g., five feet back and forth), or any other action associated with the one more infrastructure commands.

In one or more embodiments, a vehicle identifier can be generated and then associated with a particular vehicle once the functional control(s) of the particular vehicle is validated. For example, the association of the vehicle identifier with the particular vehicle provides a means for an expedited autonomous control qualification process (e.g., related to the capability determination and/or the functional control validation) where the particular vehicle can preemptively pass one or more inspections from the infrastructure-side AVM algorithm 112 in a future instance wherein the particular vehicle attempts to gain access at a certain entry location (e.g., a first entry location 310a) of the one or more entry locations 310a-310f.

For example, in an instance wherein the vehicle 102 (e.g., and/or the one or more additional vehicles 142) is associated with a vehicle identifier in relation to a particular entry location (e.g., the first entry location 310a) of the one of more entry locations 310a-310f, the vehicle 102 (e.g., and/or the one or more additional vehicles 142) can be directed toward the first entry location 310a instead of waiting to gain access to another entry location of the one or more entry locations 310b-310fto expedite the overall re-entry process to the marshaling environment 308.

As another example, the infrastructure-side AVM algorithm 112 can perform different levels of inspection and/or validation of the vehicle 102 (e.g., and/or the one or more additional vehicles 142) based on a frequency of entry/exit the vehicle 102 (e.g., and/or the one or more additional vehicles 142) makes from the marshaling environment 308.

In one or more embodiments, and in an instance wherein the infrastructure-side AVM algorithm 112 determines that the vehicle 102 (e.g., and/or the one or more additional vehicles 142) satisfies the one or more capability requirements as well as the one or more functional control requirements, the infrastructure-side AVM algorithm 112 can provide entry to the marshaling environment 308 through the one or more entry locations 310a-310f. In addition, and in an instance wherein the vehicle 102 (e.g., and/or the one or more additional vehicles 142) is autonomously controlled, the infrastructure-side AVM algorithm 112 is configured to onboard the vehicle 102 (e.g., and/or the one or more additional vehicles 142) so that the infrastructure system 110 may autonomously marshal the vehicle 102 (e.g., and/or the one or more additional vehicles 142) through the marshaling environment 308.

In one or more embodiments, and in a case wherein a human operator is detected (e.g., via at least the one or more sensors 302) within the vehicle 102 (e.g., and/or the one or more additional vehicles 142), the infrastructure-side AVM algorithm 112 is configured to initiate an authorization process to qualify the human operator for entry to the marshaling environment 308. In one or more examples, the qualification of the human operator can be based on possession of one or more credentials by the human operator as well as successful facial recognition of the human operator by at least the one or more sensors 302. As another example, and in response to successful authorization of the human operator, the infrastructure-side AVM algorithm 112 is also configured to transmit one or more entry prompts to the human operator (e.g., displayed on a screen of the vehicle infotainment system 128. As yet another example, the human operator may not be provided access to the marshaling environment 308 before the human operator acknowledges the one or more entry prompts (e.g., via a touch-screen element of the vehicle infotainment system 128 or verbally provided to the vehicle 102). As a further example, and in an instance wherein the human operator is granted entry to the marshaling environment 308, the infrastructure-side AVM algorithm 112 is configured to maintain a level of autonomous control of the vehicle 102 (e.g., and/or the one or more additional vehicles 142) wherein the infrastructure-side AVM algorithm 112 is configured to limit a speed of the vehicle 102 (e.g., and/or the one or more additional vehicles 142), a steering capability of the vehicle 102 (e.g., and/or the one or more additional vehicles 142), or any other operation-related function of the vehicle 102 (e.g., and/or the one or more additional vehicles 142).

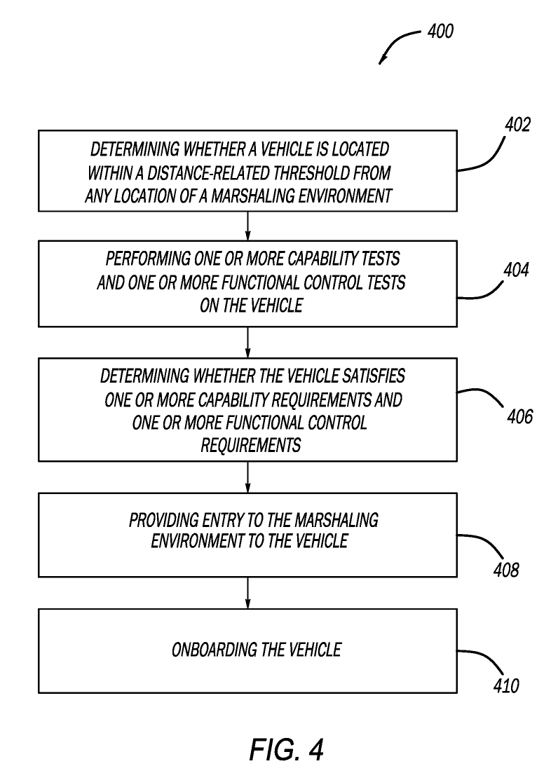

FIG. 4 is a flowchart illustrating an example method 400 for providing a means for onboarding a vehicle (e.g., the vehicle 102 and/or the one or more additional vehicles 142) upon providing entry of the vehicle to a marshaling environment (e.g., the marshaling environment 308).

At operation 402, an infrastructure system (e.g., the infrastructure system 110) is configured to determine whether the vehicle is located within a distance-related threshold from any entry location (e.g., the one or more entry locations 310a-310f) of the marshaling environment.

At operation 404, the infrastructure system is also configured to perform one or more capability tests and/or one or more functional control tests on the vehicle. In one or more examples, the one or more capability tests and/or the one or more functional control tests are performed in response to determining that the vehicle is located within the distance-related threshold from the entry location of the marshaling environment.

In one or more examples, the performance of the one or more capability tests includes a synchronization of the infrastructure system with one or more vehicle controls of the vehicle as well as monitoring one or more sensor outputs of the vehicles. As another example, the one or more sensor outputs correspond to outputs originating from one or more vehicle systems of the vehicle. As yet another example, the one or more vehicle systems include at least one of an imaging system, a powertrain system, a braking system, a steering system, and a climate system.

In one or more examples, the performance of the one or more capability tests also includes an assessment of one or more capabilities of a sensor suite (e.g., the plurality of on-board sensors 204) of the vehicle as well as a determination of whether the one or more capabilities are operational. As another example, the assessment of the one or more capabilities of the sensor suite of the vehicle is based on the synchronization of the infrastructure system with the one or more vehicle controls. As yet another example, the one or more capabilities includes at least one of a field of vision, a sensor fidelity, a powertrain accuracy control, and a powertrain control precision. As a further example, the determination of whether the one or more capabilities are operational is based on the assessment of the one or more capabilities of the sensor suite. As an additional example, the determination of whether the one or more capabilities are operational is further based on historical test data and one or more operational vehicle requirements associated with the marshaling environment.

In one or more examples, the performance of the one or more functional control tests includes a transmission of one or more instructions to the vehicle as well as causing the vehicle to perform one or more actions. As another example, the vehicle is caused to perform the one or more actions based on the one or more instructions. As yet another example, the one or more actions include at least one of a steering-related action, a light-related action, a vehicle movement-related action, and a brake-related action.

In one or more examples, the performance of the one or more functional control tests also includes a determination of whether the performance of the one or more actions corresponds to the one or more instructions as well as a generation of a vehicle identifier associated with the vehicle. As another example, the vehicle identifier associated with the vehicle is generated in response to determining that the performance of the one or more actions correspond to the one or more instructions.

At operation 406, the infrastructure system is further configured to determine whether the vehicle satisfies one or more capability requirements and/or one or more functional control requirements. In one or more examples, the determination of whether the vehicle satisfies the one or more capability requirements and/or the one or more functional control requirements is based on the performance of the one or more capability tests and the one or more functional control tests, respectively.

At operation 408, the infrastructure system is additionally configured to provide (e.g., to the vehicle) entry to the marshaling environment. In one or more examples, entry to the marshaling environment is provided to the vehicle in response to determining that the vehicle satisfies the one or more capability requirements and the one or more functional control requirements.

At operation 410, the infrastructure system is configured to onboard the vehicle to be autonomously marshaled through the marshaling environment. In one or more examples, the vehicle is onboarded in response to the vehicle entering the marshaling environment.

In one or more embodiments, the infrastructure system is also configured to determine whether a human operator is present within the vehicle. The infrastructure system is additionally configured to authorize entry of the human operator to the marshaling environment as well as display one or more entry prompts to the human operator. In one or more examples, the authorization of the entry of the human operator to the marshaling environment is based on one or more access requirements of the marshaling environment. As another example, the authorization of the entry of the human operator to the marshaling environment is also based on one or more credentials of the human operator. As yet another example, the entry of the human operator to the marshaling environment is authorized in response to determining that the human operator is present within the vehicle. As a further example, and in an instance wherein the human operator is determined to be present within the vehicle, entry to the marshaling environment is provided to vehicle based on the human operator successfully acknowledging the one or more entry prompts.

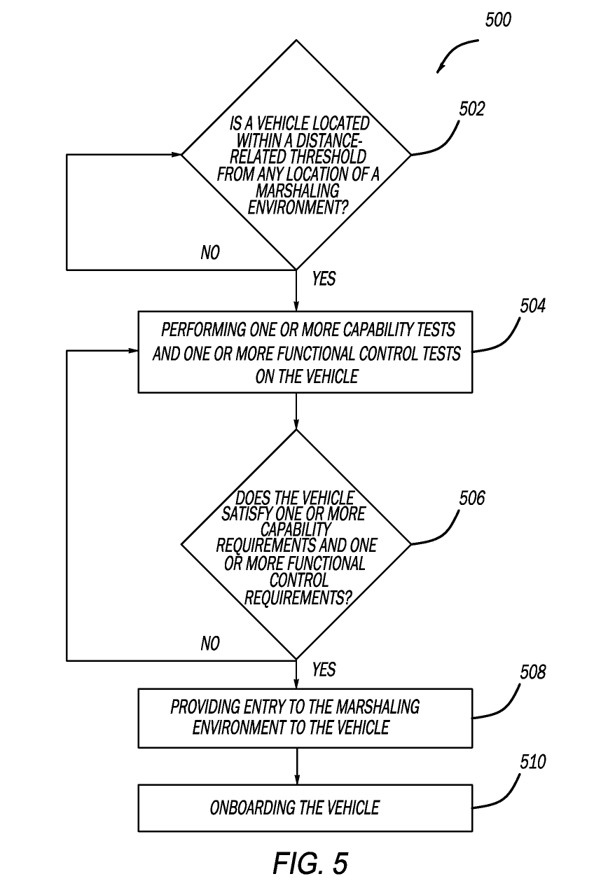

FIG. 5 is a flowchart illustrating an example method 500 for providing another means for onboarding a vehicle (e.g., the vehicle 102 and/or the one or more additional vehicles 142) upon providing entry of the vehicle to a marshaling environment (e.g., the marshaling environment 308).

At operation 502, an infrastructure system (e.g., the infrastructure system 110) is configured to determine whether the vehicle is located within a distance-related threshold from any entry location (e.g., the one or more entry locations 310a-310f) of the marshaling environment.

In an instance wherein the vehicle is determined to be located outside the distance-related threshold from any of the one or more entry locations, the infrastructure system is configured to repeat the operation 502 to determine whether the vehicle is located within the distance-related threshold from any of the one or more entry locations.

However, in a case wherein the vehicle is determined to be located within the distance-related threshold from any of the one or more entry locations, the infrastructure system is also configured to perform one or more capability tests and/or one or more functional control tests on the vehicle at operation 504. In one or more examples, the one or more capability tests and/or the one or more functional control tests are performed in response to determining that the vehicle is located within the distance-related threshold from the entry location of the marshaling environment.

At operation 506, the infrastructure system is further configured to determine whether the vehicle satisfies one or more capability requirements and/or one or more functional control requirements. In one or more examples, the determination of whether the vehicle satisfies the one or more capability requirements and/or the one or more functional control requirements is on the performance of the one or more capability tests and the one or more functional control tests, respectively.

In an instance wherein the vehicle does not satisfy the one or more capability requirements and/or the one or more functional control requirements, the infrastructure system is configured to repeat the operation 506 to determine whether the vehicle satisfies one or more capability requirements and/or one or more functional control requirements.

However, in a case wherein the vehicle satisfies the one or more capability requirements and/or one or more functional control requirements, the infrastructure system is further configured to provide (e.g., to the vehicle) entry to the marshaling environment at operation 508. In one or more examples, entry to the marshaling environment is provided to the vehicle in response to determining that the vehicle satisfies the one or more capability requirements and the one or more functional control requirements.

In response to the vehicle entering the marshaling environment, the infrastructure system is configured to onboard the vehicle to be autonomously marshaled through the marshaling environment at operation 510.

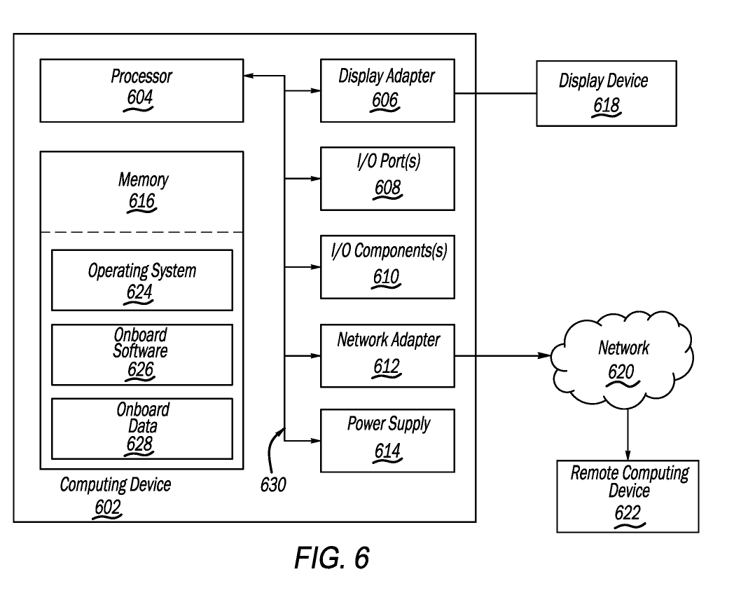

FIG. 6 illustrates an operating environment, such as a computer system, that facilitates the performance of the one or more systems and methods described herein. More specifically, the systems and methods described herein can be implemented using a computing device 602. For example, the computing device 602 can be a personal computer, a desktop, a laptop, a tablet, a hand-held computer, a server, a workstation, a mainframe, a wearable computer, a supercomputer, or a combination thereof. However, it is understood that the aforementioned examples of the computing device 602 is non-exhaustive and the computing device 602 can be any type of processing or computing device. The computing device 602 generally includes a processor 604, a display adapter 606, one or more input/output port(s) 608, one or more input/output component(s) 610, a network adapter 612, a power supply 614, and a memory 616. However, it is understood that the computing device 602 can include any additional components therein and is not required to include any of the listed components (e.g., the processor 604, the display adapter 606, the one or more input/output port(s) 608, the one or more input/output component(s) 610, the network adapter 612, the power supply 614, and the memory 616).

The processor 604 is configured to provide instructions to the computing device 602 so that the computing device 602 can process one or more tasks including the implementation of a software program to perform one or more operations as described in more detail herein. It is also understood that the computing device 602 may include any number or processors 604 therein. The display adapter 606 can be a graphics card or a video board that provides the computing device 602 with a capability to display content on a display device 618. For example, the display device 618 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of the display device 618 is non-exhaustive and that the display device 618 can be any type of device capable of providing a visual display.

The input/output port(s) 608 provide a number of interfaces (e.g., sockets) for one or more cables to connect to the computing device 602. It is understood that there may be any number of input/output port(s) 608 on the computing device 602. For example, the input/output port(s) 608 provides a means for the computing device 602 to receive signals and/or data from an external device connected to the computing device 602 via the one or more cables. As another example, the input/output port(s) 608 provide a means for the computing device 602 to send signals and/or data to an external device connected to the computing device 602 via the one or more cables. The input/output component(s) 610 can include one or more components that support the input/output port(s) 608 such as, but not limited to, a switch, a push button, a pressure mat, a float switch, a keypad, a radio receive, or a combination thereof.

The network adapter 612 can be any type of network interface controller that is configured to provide a means for communicating over a network 620 with another computing device, such as a remote computing device 622. For example, the remote computing device 622 can be a user device such as a cellular-phone, a smartphone, a tablet, a laptop, or a combination thereof. The power supply 614 is configured to convert alternating high voltage current (e.g., AC) into direct current (e.g., DC) to provide power to the other components (e.g., the processor 604, the display adapter 606, the one or more input/output port(s) 608, the one or more input/output component(s) 610, the network adapter 612, and the memory 616) of the computing device 602.

Additionally, the memory 616 can be a mass storage device and/or a system memory such as a hard disk drive, a memory card, a solid-state drive, random access memory (RAM), or a combination thereof. The memory 616 is configured to provide storage for instructions and data associated with the operation of the computing device 602. The memory 616 can generally include an operating system 624, onboarding software 626, and onboarding data 628. For example, the operating system 624 is configured to manage and/or process any of the data and/or instructions associated with the onboarding software 626 and/or onboarding data 628, as described in more detail herein, such as to onboard one or more vehicles.

Furthermore, a system bus 630 is also included within the computing device 602 that is configured to couple each of the various components (e.g., the processor 604, the display adapter 606, the one or more input/output port(s) 608, the one or more input/output component(s) 610, the network adapter 612, the power supply 614, and the memory 616) of the computing device 602. It is also understood that each of the components of the computing device 602, and the functionality associated with each of the components of the computing device 602, may be implemented within the remote computing device 622. While the operating environment illustrated within FIG. 6 depicts a particular configuration associated with at least the computing device 602, the network 620, and the remote computing device 622, it is understood that the operating environment may be configured in any way.

Thus, one or more examples of the present disclosure provide a means for integrating/re-integrating a vehicle into a marshaling environment based on an optimized manner of authorizing the vehicle (e.g., via the infrastructure-side AVM algorithm 112) before providing entry of the vehicle to the marshaling environment.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
determining, by an infrastructure system, whether a vehicle is located within a distance-related threshold from an entry location of a marshaling environment;
performing one or more capability tests and one or more functional control tests on the vehicle in response to determining that the vehicle is located within the distance-related threshold from the entry location of the marshaling environment;
determining whether the vehicle satisfies one or more capability requirements and one or more functional control requirements based on the performance of the one or more capability tests and the one or more functional control tests, respectively;
providing, to the vehicle, entry to the marshaling environment in response to determining that the vehicle satisfies the one or more capability requirements and the one or more functional control requirements; and
onboarding the vehicle to be autonomously marshaled through the marshaling environment in response to the vehicle entering the marshaling environment.

2. The method of claim 1, wherein performing the one or more capability tests comprises:
synchronizing the infrastructure system with one or more vehicle controls of the vehicle; and
monitoring one or more sensor outputs of the vehicle based on the synchronization of the infrastructure system with the one or more vehicle controls, wherein the one or more sensor outputs correspond to outputs originating from one or more vehicle systems of the vehicle, and wherein the one or more vehicle systems include at least one of an imaging system, a powertrain system, a braking system, a steering system, and a climate system.

3. The method of claim 2, wherein performing the one or more capability tests comprises:
assessing one or more capabilities of a sensor suite of the vehicle based on the synchronization of the infrastructure system with the one or more vehicle controls, wherein the one or more capabilities includes at least one of a field of vision, a sensor fidelity, a powertrain accuracy control, and a powertrain control precision; and
determining whether the one or more capabilities are operational based on the assessment of the one or more capabilities of the sensor suite.

4. The method of claim 3, wherein determining whether the one or more capabilities are operational is further based on historical test data and one or more operational vehicle requirements associated with the marshaling environment.

5. The method of claim 1, wherein performing the one or more functional control tests comprises:
transmitting one or more instructions to the vehicle; and
causing the vehicle to perform one or more actions based on the one or more instructions, wherein the one or more actions include at least one of a steering-related action, a light-related action, a vehicle movement-related action, and a brake-related action.

6. The method of claim 5, wherein performing the one or more functional control tests comprises:
determining whether the performance of the one or more actions correspond to the one or more instructions; and
generating a vehicle identifier associated with the vehicle in response to determining that the performance of the one or more actions correspond to the one or more instructions.

7. The method of claim 1, further comprising:
determining whether a human operator is present within the vehicle;
authorizing, based on one or more access requirements of the marshaling environment, entry of the human operator to the marshaling environment further based on one or more credentials of the human operator and in response to determining that the human operator is present within the vehicle; and
displaying one or more entry prompts to the human operator.

8. The method of claim 7, wherein providing entry to the marshaling environment is based on the human operator successfully acknowledging the one or more entry prompts.

9. A system comprising:
an infrastructure system configured to:
determine whether a vehicle is located within a distance-related threshold from an entry location of a marshaling environment,
perform one or more capability tests and one or more functional control tests on the vehicle in response to determining that the vehicle is located within the distance-related threshold from the entry location of the marshaling environment,
determine whether the vehicle satisfies one or more capability requirements and one or more functional control requirements based on the performance of the one or more capability tests and the one or more functional control tests, respectively,
provide, to the vehicle, entry to the marshaling environment in response to determining that the vehicle satisfies the one or more capability requirements and the one or more functional control requirements, and
onboard the vehicle to be autonomously marshaled through the marshaling environment in response to the vehicle entering the marshaling environment; and
the vehicle configured to:
receive one or more instructions at the vehicle, and
perform one or more actions based on the one or more instructions, wherein the one or more actions include at least one of a steering-related action, a light-related action, a vehicle movement-related action, and a brake-related action.

10. The system of claim 9, wherein the infrastructure system configured to perform the one or more capability tests is further configured to:
synchronize the infrastructure system with one or more vehicle controls of the vehicle; and
monitor one or more sensor outputs of the vehicle based on the synchronization of the infrastructure system with the one or more vehicle controls, wherein the one or more sensor outputs correspond to outputs originating from one or more vehicle systems of the vehicle, and wherein the one or more vehicle systems include at least one of an imaging system, a powertrain system, a braking system, a steering system, and a climate system.

11. The system of claim 10, wherein the infrastructure system configured to perform the one or more capability tests is further configured to:
assess one or more capabilities of a sensor suite of the vehicle based on the synchronization of the infrastructure system with the one or more vehicle controls, wherein the one or more capabilities includes at least one of a field of vision, a sensor fidelity, a powertrain accuracy control, and a powertrain control precision; and
determine whether the one or more capabilities are operational based on the assessment of the one or more capabilities of the sensor suite, historical test data, and one or more operational vehicle requirements associated with the marshaling environment.

12. The system of claim 9, wherein the infrastructure system configured to perform the one or more functional control tests is further configured to:
determine whether the performance of the one or more actions correspond to the one or more instructions; and
generate a vehicle identifier associated with the vehicle in response to determining that the performance of the one or more actions correspond to the one or more instructions.

13. The system of claim 9, wherein the infrastructure system is further configured to:
determine whether a human operator is present within the vehicle;
authorize, based on one or more access requirements of the marshaling environment, entry of the human operator to the marshaling environment further based on one or more credentials of the human operator and in response to determining that the human operator is present within the vehicle; and
display one or more entry prompts to the human operator.

14. The system of claim 13, wherein the provision of the entry to the marshaling environment is based on the human operator successfully acknowledging the one or more entry prompts.

15. One or more non-transitory computer-readable media storing processor-executable instructions that, when executed by at least one processor, cause the at least one processor to:
determine, by an infrastructure system, whether a vehicle is located within a distance-related threshold from an entry location of a marshaling environment;
perform one or more capability tests and one or more functional control tests on the vehicle in response to determining that the vehicle is located within the distance-related threshold from the entry location of the marshaling environment;
determine whether the vehicle satisfies one or more capability requirements and one or more functional control requirements based on the performance of the one or more capability tests and the one or more functional control tests, respectively;
provide, to the vehicle, entry to the marshaling environment in response to determining that the vehicle satisfies the one or more capability requirements and the one or more functional control requirements; and
onboard the vehicle to be autonomously marshaled through the marshaling environment in response to the vehicle entering the marshaling environment.

16. The one or more non-transitory computer-readable media of claim 15, wherein the at least one processor caused to perform the one or more capability tests is further caused to:
synchronize the infrastructure system with one or more vehicle controls of the vehicle; and
monitor one or more sensor outputs of the vehicle based on the synchronization of the infrastructure system with the one or more vehicle controls, wherein the one or more sensor outputs correspond to outputs originating from one or more vehicle systems of the vehicle, and wherein the one or more vehicle systems include at least one of an imaging system, a powertrain system, a braking system, a steering system, and a climate system.

17. The one or more non-transitory computer-readable media of claim 16, wherein the at least one processor caused to perform the one or more capability tests is further caused to:
assess one or more capabilities of a sensor suite of the vehicle based on the synchronization of the infrastructure system with the one or more vehicle controls, wherein the one or more capabilities includes at least one of a field of vision, a sensor fidelity, a powertrain accuracy control, and a powertrain control precision; and
determine whether the one or more capabilities are operational based on the assessment of the one or more capabilities of the sensor suite, historical test data, and one or more operational vehicle requirements associated with the marshaling environment.

18. The one or more non-transitory computer-readable media of claim 15, wherein the at least one processor caused to perform the one or more functional control tests is further caused to:
transmit one or more instructions to the vehicle; and
cause the vehicle to perform one or more actions based on the one or more instructions, wherein the one or more actions include at least one of a steering-related action, a light-related action, and a brake-related action.

19. The one or more non-transitory computer-readable media of claim 18, wherein the at least one processor caused to perform the one or more functional control tests is further caused to:
determine whether the performance of the one or more actions correspond to the one or more instructions; and
generate a vehicle identifier associated with the vehicle in response to determining that the performance of the one or more actions correspond to the one or more instructions.

20. The one or more non-transitory computer-readable media of claim 15, wherein the at least one processor is further caused to:
determine whether a human operator is present within the vehicle;
authorize, based on one or more access requirements of the marshaling environment, entry of the human operator to the marshaling environment further based on one or more credentials of the human operator and in response to determining that the human operator is present within the vehicle; and
display one or more entry prompts to the human operator, wherein the provision of the entry to the marshaling environment is based on the human operator successfully acknowledging the one or more entry prompts.
